(19) United States
(12) Patent Application Publication
(10) Pub. No.: US 2022/0026361 A1
(43) Pub. Date: Jan. 27, 2022

(54) ORDERED ARRAYS OF MICRODOTS

(71) Applicant: Hewlett-Packard Development Company, L.P., Spring, TX (US)

(72) Inventors: Fausto D'Apuzzo, Palo Alto, CA (US); Steven Barcelo, Palo Alto, CA (US); Raghuvir N. Sengupta, Palo Alto, CA (US)

(73) Assignee: Hewlett-Packard Development Company, L.P., Spring, TX (US)

(21) Appl. No.: 17/297,427

(22) PCT Filed: Dec. 18, 2018
(86) PCT No.: PCT/US2018/066245

§ 371 Date: May 26, 2021

(51) Int. Cl. G01N 21/64; G01N 21/65

(52) U.S. Cl. CPC G01N 21/648; G01N 21/658

(57) ABSTRACT

In an example method, an ordered array of microdots including an analyte printed on a surface of a surface-enhanced substrate of an analysis chip is probed with an excitation beam of electromagnetic radiation. Emitted radiation is detected from a number of microdots of the ordered array of microdots. Calibration data is generated for the analysis chip with respect to the analyte based on a detected shift in the emitted radiation as compared to the excitation beam.

### BACKGROUND

Sensors can be fabricated via colloid aggregation, electrochemically roughened metal surfaces, or nanoimprint lithography, among other techniques. For example, nanoimprint lithography creates patterns by mechanical deformation of imprint resist and subsequent processes. The imprint resist is typically a monomer or polymer formulation that is cured by heat or ultraviolet (UV) light during the imprinting.

### BRIEF DESCRIPTION OF THE DRAWINGS

Various features of the techniques of the present application will become apparent from the following description of examples, given by way of example only, which is made with reference to the accompanying drawings, of which:

FIG. 1 is a side view of a system for depositing and analyzing microdots on analysis chips, in accordance with examples;

FIG. 2 is a schematic diagram illustrating a process for performing a sensor performance assay, in accordance with examples;

FIG. 3 is a schematic diagram illustrating process for performing a sensor performance assay to reject defective sensors, in accordance with examples;

FIG. 4 is a top down view and two exploded side view drawings illustrating an ordered array of microdots deposited on an analysis chip having collapsible nanopillars, in accordance with examples;

FIG. 5A is a drawing illustrating a single dot pattern, in accordance with examples;

FIG. 5B is a drawing illustrating a multi-analyte pattern for an ordered array of microdots, in accordance with examples;

FIG. 5C is a drawing illustrating a multi-concentration pattern for an ordered array of microdots, in accordance with examples;

FIG. 5D is a drawing illustrating an ordered array of microdots, in accordance with examples;

FIG. 5E is a drawing illustrating an ordered array of microdots with increasing concentration, in accordance with examples;

FIG. 5F is a drawing illustrating an ordered array of microdots with multiple analytes, in accordance with examples;

FIG. 5G is a drawing illustrating a combination pattern, in accordance with examples;

FIG. 6 is a process flow diagram illustrating a method for generating calibration data, in accordance with examples;

FIG. 7 is a process flow diagram illustrating another method for generating calibration data, in accordance with examples;

FIG. 8 is block diagram of a system to generate calibration curves and perform analysis of spectral content, in accordance with examples; and

FIG. 9 is a block diagram of another system to generate calibration curves and perform analysis of spectral content, in accordance with examples.

### DETAILED DESCRIPTION

Sensors can be fabricated via colloid aggregation, electrochemically roughened metal surfaces, or nanoimprint lithography, among other techniques. However, sensor-to-sensor variability among the fabricated sensors may make working with these sensors difficult and costly. For example, a significant number of sensors that are fabricated may not meet a threshold of performance. Accordingly, many sensors that are shipped may be later found to be lacking in quality and discarded. In addition, analytes used to test the sensors after shipment may perform differently between sensors because of minor irregularities in fabrication. Thus, it may be difficult to quantify the results of assays performed on the sensors using various analytes. Moreover, while multiple calibration spots on plasmonic sensors may be used to improve accuracy and predictive power, optical interrogation becomes slower with more spots. Furthermore, keeping spot sizes small may reduce impact on usable sensor area, but may also increase susceptibility to missed spots due to defects or nonuniformities on the sensor surface.

Described herein are techniques for performing assays on analysis chips using deposited ordered arrays of microdots having analytes. As used herein, a microdot refers to a deposit of analyte that covers less than an entire surface of an object to be tested. For example, a microdot may be an area of deposited material that includes an analyte of a dispensed volume of between 20 picoliters (pL) to 100 nanoliters (nL). In some examples, a 20 pL droplet forms a microdot having a diameter of about 50 micrometers. As used herein, an analyte refers to any substance suitable for spectroscopic analysis of analysis chips. The analyte may be a molecule, or mixture of molecules. An ordered array may be a pattern of microdots dispensed on a sensor that matches a pitch or pattern of a sensor array in an optical system used to image the sensor.

The techniques enable analysis chips to be tested prior to shipment, providing calibration curves that enable quantitation of subsequent assays using an analyte. Moreover, the techniques include the use of minimal area and various configurations of microdots on the analysis chips such that the microdots used in generating the calibration curves do not affect the subsequent assays. In various examples, the techniques described herein may use less than 10% percent of sensor area for calibration of Surface-Enhanced substrates.

The techniques described herein also enable the ability to calibrate sensor performance directly by sampling with a range of analytes that can be targeted in the desired application, thus accounting for effects such as surface binding efficiency. The techniques described herein can be applied to almost any surface-enhanced plasmonic substrate, without introducing additional and complex fabrication steps.

The techniques described herein are integrated with automated optical interrogation techniques to perform several measurements on the same substrate via the ordered arrays of microdots. In particular, the high power output available in common Raman spectrometers, along with lenslet micro-arrays, enables highly parallelizable optical interrogation of the ink-jet calibration patterns, and simplification of the calibration process. The techniques thus combine visual inspection and ink-jet-based calibration in an automated device for more efficient use of viable area. In addition, using a coupled vision system enables small adjustments to the dispense system alignment to avoid dispensing onto defect regions so that sensors with an acceptable level of defects can be used, thus increasing production yields. Finally, the techniques improve quantitation by generating calibration curves to be used when performing assays on sensors using particular analytes. The techniques may thus be used to predict sensor performance, ensuring that sensors used meet a certain performance threshold. In addition, differences in sensor performance can be corrected.

More generally, the techniques described herein provide a pathway to implement efficient quality control protocols in a production line. In particular, the techniques provide for a parallel and faster spectroscopic measurement of calibration pattern via the use of lenslet microarrays.

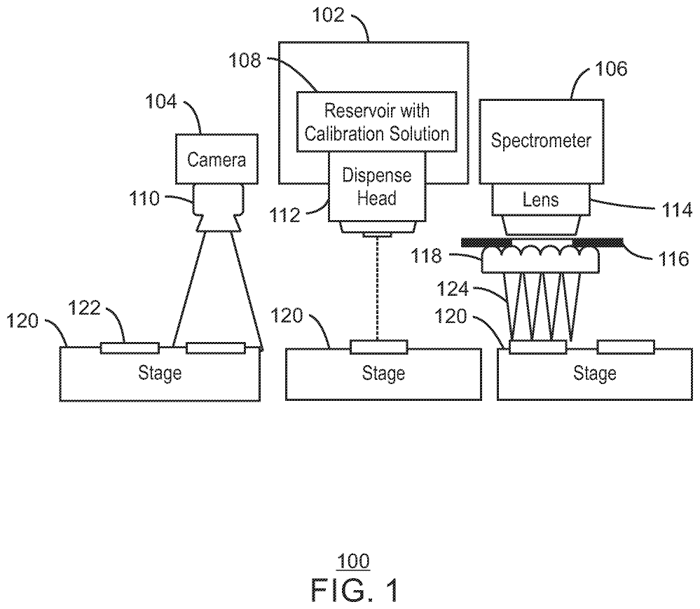

FIG. 1 is a side view of a system 100 for depositing and analyzing microdots on analysis chips, in accordance with examples. The system 100 includes a digital dispenser 102, a camera 104, and a spectrometer 106 that may be driven by a processor (not shown). The digital dispenser 102 includes a reservoir 108 with calibration solution. In various examples, the digital dispenser 102 has one or more dispensing heads that are loaded with solutions containing calibration compounds. In some examples, the calibration compounds have any number of concentrations. The camera 104 includes an electromagnetic source 110 to provide illumination. The reservoir 108 of the digital dispenser 102 is coupled to a dispense head 112. The spectrometer is coupled to a lens 114 and an iris 116. The iris 116 can control an aperture associated with a microlens array 118. The system 100 further includes stages 120 to transport analysis chips 122 for printing and analysis.

Prior to inspection, each sensor substrate of the analysis chips 122 may be inscribed with a part identifier during or after fabrication. In various examples, the part identifier is a unique identifier for each analysis chip. In some examples, the part identifier can be a combined identifier that includes a unique identifier and a wafer location identifier. For example, the part identifier may be a token, a part number, or other symbol on the analysis chip. In some examples, the part identifier can be inscribed into the surface of the analysis chips 122 using a laser scribing system. In various examples, the part identifier is included inside or outside an active area of the analysis chip. As one example, the part identifier is alphanumerical, a barcoding, or a QR-code. The camera 104 of the system 100 can be used to collect optical images of analysis chips 122 to be inspected. In some examples, a processor can detect the visual identifiers in the optical images. The processor can also extract optical features from the optical images, such as total usable area, orientation of the analysis chips 122, and other visual features related to sensor quality. In some examples, the other visual features can include presence of defects. As one example, the defects are areas with missing patterns.

The dispense head 112 is part of a microfluidic ejector array that can be used to deposit an ordered array of microdots onto the analysis chips 122. In some examples, a pitch of the ordered array of microdots may match a pitch of the microlens array 118. As used herein, a pitch of the ordered array of microdots refers to a distance between the centers of the dots. A pitch of the microlens array 118 refers to a distance between the centers of microlenses in the microlens array 118. In some examples, the dispense head 112 is a thermal inkjet (TIJ) dispense head. For example, the microfluidic ejectors of the digital dispenser 102 can use thermal resistors to eject fluid from nozzles by heating to create bubbles that force fluid from the nozzles. In other examples, the microfluidic ejectors use piezoelectric cells to force fluid from the nozzles.

The spectrometer 106 can be used to collect single point spectra or hyperspectral images of analysis chips 122 having the ordered arrays of microdots thereon. In some examples, the spectrometer 106 may be an imaging system, a multichannel spectrophotometer, or any number of other optical sensors. The lens 114 can process light 124 arriving from one of the analysis chips 122 and focus the light 124 onto the spectrometer 106. In some examples, the spectrometer 106 includes a monochromator that allows a narrow frequency band of the light 124 to reach the detector elements in the spectrometer 106. In various examples, the monochromator is adjusted to different frequencies of the light 124 for operation. In other examples, the spectrometer 106 divides the incoming light 124 into different channels, each of which are sent to a different sensor within the spectrometer 106, providing multispectral analysis of the incoming light 124. In various examples, the spectrometer 106 can be used to perform brightfield, dark-field, florescence, Raman, infrared absorption, hyperspectral, and other optical analyses. As used herein, a hyperspectral analysis system uses multiple frequencies of light to analyze an image.

The lens 114 is a focusing lens used to collect the light 124 coming from the sensors 106 into the spectrometer 106. In various examples, the lens 114 is a single lens, a group of lenses, or other optical apparatus. In an example, the lens 114 is a Fresnel lens, providing a wide area lens without adding significant complexity. In other examples, the lens 114 is integrated with the optical system, and includes multiple elements, such as a microscopy objective. In some examples, the lens 114 may provide a magnification of 4× or greater.

The stages 120 may be moved to place different analysis chips 122 under the camera 104, the dispense head 112, and the spectrometer 106. In various examples, the analysis chips 122 are individual sensors on a multi-sensor wafer, a set of individual sensors, or any combinations thereof. In some examples, a stage 120 is an x-y-z translation stage, or x-y-z stage, that can move any of a number of analysis chips 122 in an x-y-z grid in a multi-sensor wafer. In other examples, the stage 120 is a linear translation stage that can move analysis chips 122 under the dispense head 112 of a microfluidic ejector in a microfluidic ejector array for deposition of ordered arrays of microdots onto the surface thereof. The stage 120 may also be used to move different positions of analysis chips 122 under the dispense head 112 to deposit the microdots.

The analysis chips 122 may be illuminated using any number of different techniques. For example, the camera 104 and spectrometer 106 may include a co-linear illumination system. In some examples, the light source for the spectrometer 106 is a laser, such as a laser photodiode.

The reservoir 108 holds a fluid that is a calibration solution to be ejected from the dispense head 112. In one example, the fluid includes an analyte. In another example, the reservoir 108 holds a fluid that includes multiple analytes. The reservoir 108 feeds into a chamber (not shown) that feeds the dispense head 112 of a microfluidic ejector array. In one example, the chamber may be around 6 millimeters (mm) in size and is fluidically coupled to the nozzles of the dispense head 112 of the microfluidic ejector array.

The system 100 includes a processor (not shown) that is coupled to the camera 104 and the spectrometer 106 through a data link (not shown). The processor may analyze images from the camera 104 to identify target regions to print the ordered array of microdots in the analysis chips 122. The processor is also coupled through control links (not shown) to the microfluidic ejectors of the dispense head 112 and to motors controlling the stages 120.

In an example, the processor causes the camera 104 to capture an image of an analysis chip 122. The processor also causes the dispense head 112 to fire the microfluidic ejectors of a microfluidic ejector array. The processor may then cause a stage 120 to be moved to place the analysis chip 122 under the spectrometer 106 and then cause the spectrometer 106 to analyze the analysis chip 122. The stage 120 may be moved to allow depositing onto a calibration region of each of the analysis chips 122. For example, the calibration region may be a small portion of a surface of each of the analysis chips 122, such as an identified dispense location detected based on one or more extracted optical features of each analysis chip 122.

In another example, when the processor detects a target emission from a spectrometer 106, the processor uses the motors of the stage 120 to move a subsequent analysis chip 122 into range for analysis by the spectrometer 106. The processor then activates a microfluidic ejector in the dispense head 112 to eject an ordered array of microdots onto another analysis chip 122 to be subsequently analyzed. The processor then moves a different analysis chip 122, to be deposited with an ordered array of microdots and analyzed via the spectrometer 106 in a similar manner.

The spectrometer 106 includes an optical device that is used to probe the materials in the analysis chip 122. In various examples, the optical device is a spectrometer, microscope, fluorimeter, a particle size analyzer, an image recognition system, or a combination thereof. The spectrometer 106 includes a lenslet microarray. The lenslet microarray works in tandem with a microscope objective. In some examples, the lenslet microarray is used in place of a microscope objective. The lenslet microarray simultaneously measures a number of microdots in the ordered array of microdots of the calibration pattern.

In some examples, the spectrometer 106 includes a laser that provides a source of illumination. In various examples, the microlens array 118 focuses the laser beam into an array of focal points having a pitch that matches the ordered array of microdots. For example, the pitch is 50-500 microns. The spectrometer 106 can further include a line filter, a reflective surface, and a reflective source. The line filter may be a narrow bandpass filter centered on a particular wavelength. In some examples, the reflective surface is a partially silvered mirror or a prism, or another type of beam splitter, that directs the illumination from the laser through the focusing lens onto the stage 120 to illuminate the analysis chips 122. In some examples, the laser may alternatively be a co-linear light source that may include any number of sources of illumination. In an example, the co-linear light source includes an array of light emitting diodes. In some examples, the co-linear light source is a laser and optics such as a lens 114. The lens 114 can expand the beam of illumination and direct the beam of incoming light linearly into the spectrometer 106.

The iris 116 controls an aperture associated with the microlens array 118. In various examples, the iris 116 is used to control the number of lenslets illuminated by a beam, thus controlling the number and arrangement of an array of focal points of light 124 projected onto each analysis chip 122.

In some examples, incoming light 124 returning from the analysis chip 122 bounces off reflective surfaces, through an edge filter, and then bounces of another reflective surface to reach a lens 114. The lens 114 collects the incoming light 124 onto the spectrometer 106. In some examples, to enhance the amount of light 124 received by the spectrometer 106, filters (not shown) are placed between the laser and the sensors and between the sensors and the detector array. In an example, the filters are at an excitation band, such as a 5 nanometer (nm) bandpass filter centered on a wavelength of about 785 nm, at the line filter, and at an emission band, such as low-pass edge filter with a cutoff wavelength of about 800 nm, at the edge filter. The reflective surfaces may include a dichroic filter that enables a band of illumination from the laser to pass through, while reflecting incoming light 124. In another example, the filters are polarizing filters that are placed perpendicular to each other.

The block diagram of FIG. 1 is not intended to indicate that the system 100 is to include all of the components shown in FIG. 1. Further, the system 100 may include any number of additional components not shown in FIG. 1, depending on the details of the specific implementation. For example, the system 100 may include additional stages, analysis chips, cameras, reservoirs, dispense heads, spectrometers, lenses, etc.

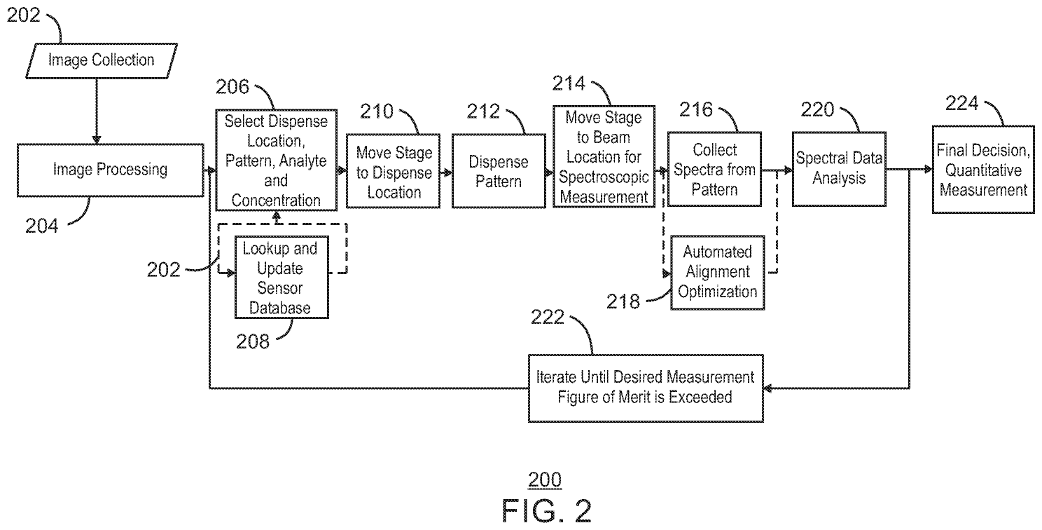

FIG. 2 is a schematic diagram illustrating a process for performing a sensor performance assay, in accordance with examples. At block 202, a number of images are collected. For example, the images include analysis chips to be printed.

At block 204, the images are processed. For example, the image processing includes extracting visual references and identifiers from the images. In some examples, the image processing includes evaluating surface homogeneity and detecting availability of areas for printing ordered arrays of microdots.

At block 206, a dispense location, a pattern, and an analyte concentration are selected. In various examples, the dispense location is selected based on the detected available areas for printing. In some examples, the analytes and concentration is selected based on information retrieved using the identifiers. For example, the information is retrieved from a database using the identifier.

At block 208, a sensor database is looked up and updated. For example, the sensor database is looked up using an extracted part identifier of each analysis chip. In various examples, the sensor database is updated with sensor quality features captured by the camera and compared to any previous data.

At block 210, the stage is moved to a dispense location. In various examples, the dispense location is based on surface homogeneity.

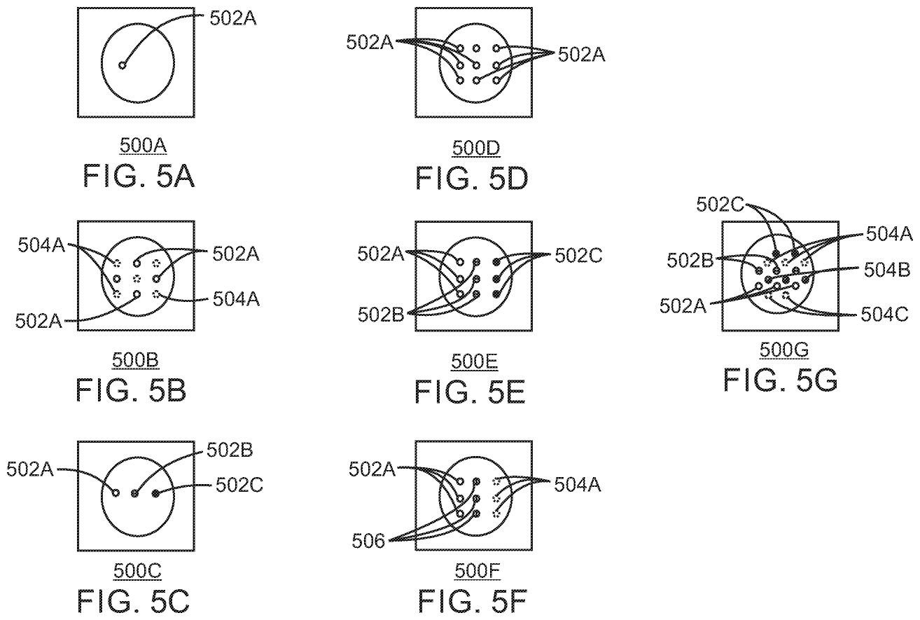

At block 212, a pattern is dispensed onto the analysis chip. In some examples, the pattern is an ordered array of microdots. For example, the pattern of microdots is any of the patterns described in FIGS. 5B-5G.

At block 214, the stage is moved to a beam location for spectroscopic measurement. In various examples, the beam location is preset based on the pattern used for the ordered array of microdots.

At block 216, spectra are collected from the pattern on the analysis chip. In various examples, the spectra are collected by illuminating the ordered array of microdots with electromagnetic radiation and capturing the reflected radiation using a spectrometer. In some examples, the spectra are collected by illuminating the ordered array of microdots with an array of laser beams having the same pitch as the ordered array of microdots. In some examples, spectra are simultaneously collected from a row or a column of the ordered array of microdots. In other examples, spectra are simultaneously collected from the entire ordered array of microdots.

At block 218, an automated alignment optimization is performed. In various examples, the automated alignment optimization aligns an array of laser focal points with the ordered array of microdots on the surface of the analysis chip. For example, the automated alignment optimization is performed in response to detecting that a magnitude of the spectra be maximized.

At block 220, a spectral data analysis is performed. In various examples, the spectral data analysis includes a comparison of wavelengths from each of the microdots in the ordered array of microdots and a determination of a shift in the wavelengths.

At block 222, blocks 206-220 are iterated until a desired measurement figure of merit is exceeded. In various examples, the figure of merit is a threshold concentration accuracy.

At block 224, a final decision and quantitative measurement is output. In various examples, the final decision is to exclude an analysis chip from shipping if the analysis chip does not exceed a performance threshold. In some examples, the final decision is to ship the analysis chip if the analysis chip exceeds a performance threshold. In various examples, the quantitative measurement is stored in a database using a part identifier of the analysis chip. The quantitative measurement is later retrieved from the database using the part identifier.

It is to be understood that the process diagram of FIG. 2 is not intended to indicate that all of the elements of the process 200 are to be included in every case. Further, any number of additional elements not shown in FIG. 2 may be included in the process 200, depending on the details of the specific implementation. In some examples, the process 200 includes extracting the part identifier during image processing.

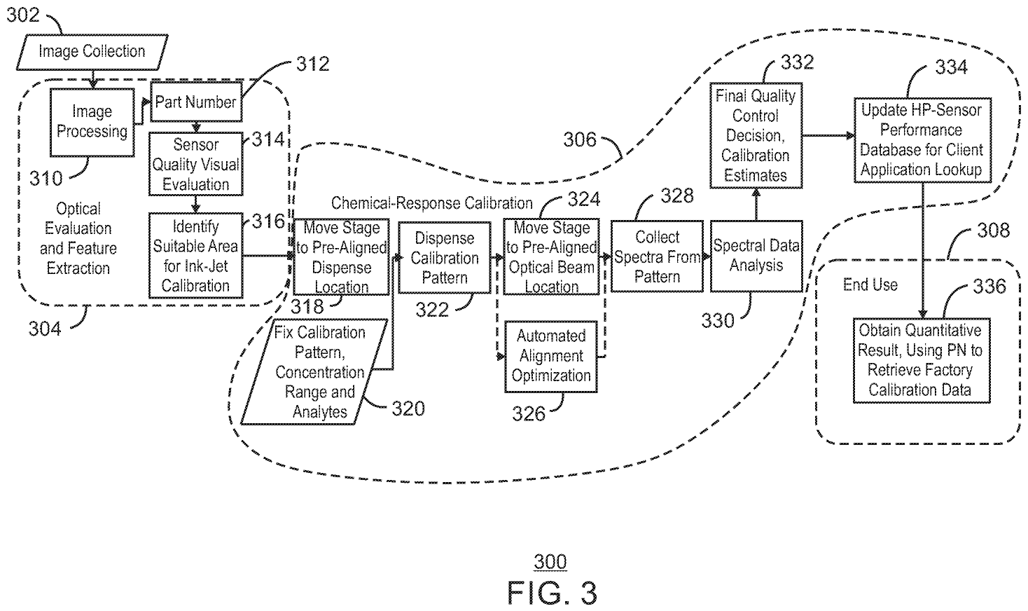

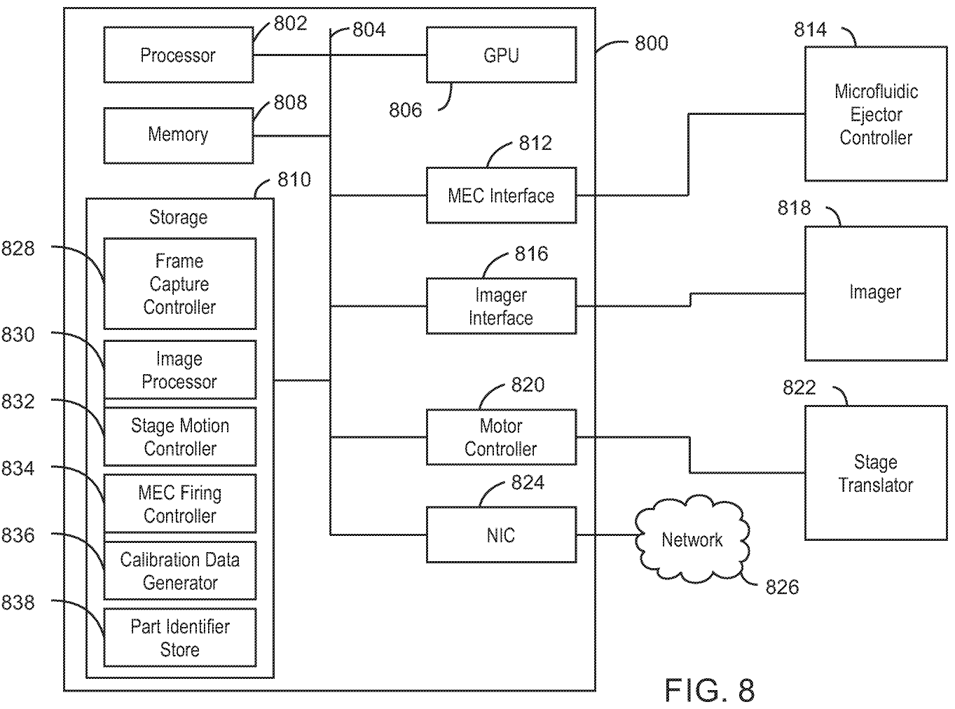

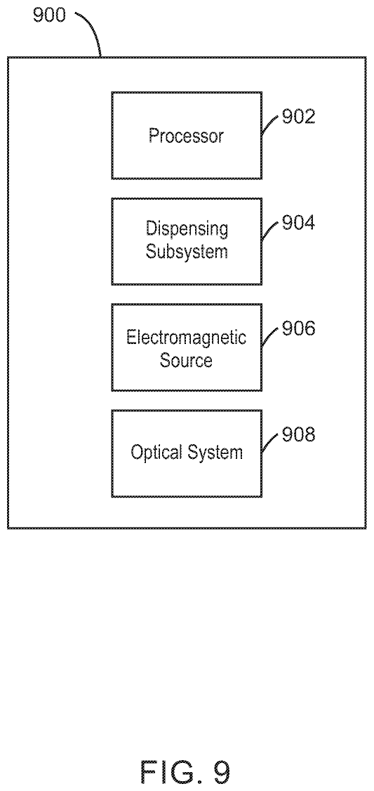

FIG. 3 is a schematic diagram illustrating a process for performing a sensor performance assay to reject defective sensors, in accordance with examples. The process 300 of FIG. 3 can be implemented in the system 100 of FIG. 1 or the processors 802 or 902 of FIGS. 8 and 9.

The process 300 of FIG. 3 includes, at block 302, collecting images of analysis chips. For example, the images are taken using a camera. In some examples, the camera is above and facing perpendicularly towards the surfaces of the analysis chips. Generally, the process 300 further includes performing an optical evaluation and feature extraction 304. The process 300 also includes a chemical-response calibration 306. The process 300 also further includes an end use 308 of the chemical-response calibration.

At block 310, the optical evaluation and feature extraction 304 includes processing the images. For example, the image processing includes extracting visual references and identifiers from the images. For example, the identifiers may include a part number 312. In some examples, the image processing includes evaluating surface homogeneity and detecting availability of areas for printing ordered arrays of microdots.

At block 314, the optical evaluation and feature extraction 304 includes performing a sensor quality visual evaluation. In various examples, the sensor quality visual evaluation includes a surface analysis. In some examples, the surface analysis includes an estimation of a total ratio of active area on the analysis chip. For example, the estimation can be performed by image scaling, thresholding, or circle recognition, among other possible techniques. In some examples, the surface analysis includes an estimation of uniformity of the surface of the analysis chip. For example, the estimation of uniformity can be performed using gradient analysis, roughness, or edge detection, among other techniques. In some examples, a combination of surface and shape algorithms can be used to predict a maximum area that could be covered by the intended laser beam size and profile.

At block 316, the optical evaluation and feature extraction 304 includes identifying a suitable area for ink-jet calibration. In various examples, the suitable area is identified based on surface uniformity and active area size.

At block 318, the stage is moved to a predetermined dispense location corresponding to an area on the sensor identified in the previous step by the surface image analysis. In various examples, the dispense location is decided based on the detected available areas for printing.

At block 320, a calibration pattern, and an analyte concentration range and analytes to use are fixed. In some examples, the analytes and concentration is decided based on information retrieved using the identifiers. For example, the information is retrieved from a database using the identifier. In some examples, the calibration spotting pattern is matched to the pitch of the lenslet microarray. As one example, a 300 microns pitch is used for both the calibration pattern and the lenslet microarray. In some examples, a pitch in the range of 50-500 microns is used for both the calibration pattern and the lenslet microarray.

At block 322, the calibration pattern is dispensed. In various examples, the calibration pattern is an ordered array of microdots dispensed using an inkjet printer.

At block 324, the stage is moved to a pre-aligned optical beam location. In various examples, the optical beam location is pre-aligned to match the pitch and position of the ordered array of microdots.

At block 326, an automated alignment optimization is performed. In various examples, a fine adjustment of the position of the ordered array of microdots is performed to place the ordered array of microdots directly under an array of laser beam focal points. In some examples, the number of laser beam focal points is equal to or less than the number of microdots in the ordered array of microdots. In various examples, an optimization routine can include auto-alignment and autofocus of the sample to the array of laser beam focal points in an automated fashion in order to minimize human intervention.

At block 328, spectra are collected from the calibration pattern. In various examples, the spectra are collected simultaneously from a number of microdots in the calibration pattern via an aligned array of laser beam focal points.

At block 330, a spectral data analysis is performed. In various examples, the spectra are Raman spectra are collected and baselined. In some examples, other preprocessing is performed, such as signal detection or smoothing. In various examples, the calibration spot intensities are averaged and fitted to a regression model to estimate sensitivity. In some examples, calibration intensities can be fitted to a non-linear model. As one example, the non-linear model is a Langmuir isotherm model.

At block 332, a final quality control decision and calibration estimates are generated. In various examples, image and spectral results are compared to quality control thresholds or combined into single metrics. In some examples, calibration data can be rescaled by the available active area ratio. As one examples, the calibration data includes estimated sensitivity. In some examples, sensitivity can be rescaled by a combination of an area ratio, a shape and laser profile. In various examples, image and spectral data can be used to train a machine learning regression model for sensor performance scoring. Thus, defective analysis chips can be filtered out in advance based on the outcome of the spectral data analysis before the sensors are delivered for additional performance testing.

At block 334, a sensor performance database for client application lookup is updated. In various examples, the sensor performance database is updated using a part identifier of an analysis chip to include generated calibration data for the analysis chip in the sensor performance database.

At block 336, the end use 308 includes obtaining a quantitative result by comparing the user data to a look-up table, or to calibration data that are retrieved from the factory database using the part number or unique sensor identifier. In various examples, the quantitative result includes an estimate of the analyte concentration or mixture ratios for complex compounds.

It is to be understood that the process diagram of FIG. 3 is not intended to indicate that all of the elements of the process 300 are to be included in every case. Further, any number of additional elements not shown in FIG. 3 may be included in the process 300, depending on the details of the specific implementation.

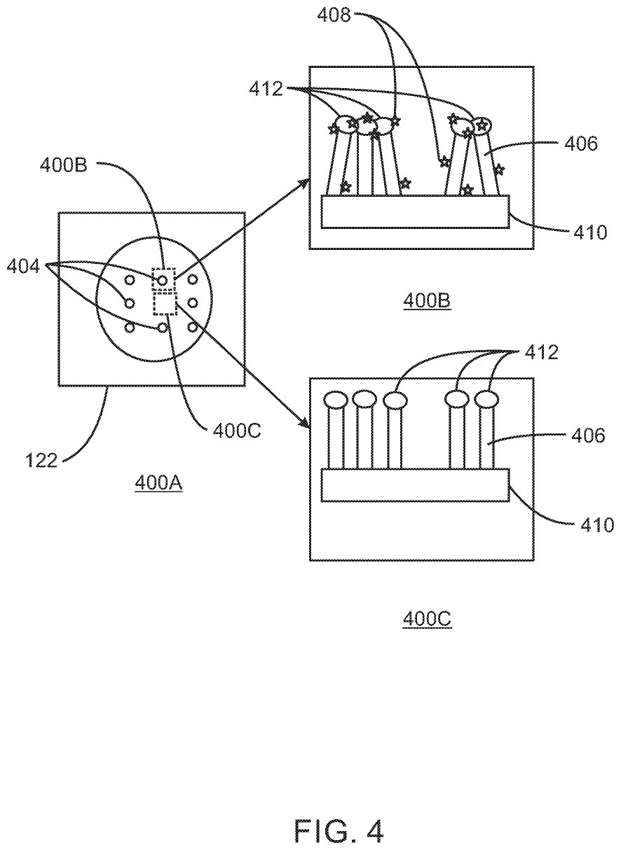

FIG. 4 is a top down view 400A and two exploded side views 400B, 400C illustrating an ordered array of microdots 404 deposited on an analysis chip 122 having collapsible nanopillars 406 partially covered with analytes 408 and coupled to a substrate 410, in accordance with examples. For example, the collapsible nanopillars 406 may be polymer shafts with metal caps 412. The collapsible nanopillars 406 may be formed from a column layer on the surface of the substrate 410 by any number processes, including nano-embossing, lithography followed by reactive ion etching or chemical etching, and the like. The column layer may be a polymeric material that can be formed into columns by any number of processes. Polymeric materials that may be used include but are not limited to, photo resists, hard mold resins such as PMMA, soft mold polymers such as PDMS, ETFE or PTFE, or hybrid-mold cross-linked, UV-curable or thermal-curable, polymers based on acrylate, methacrylate, vinyl, epoxy, siloxane, peroxide, urethane or isocyanate. The polymer materials may be modified to improve imprint and mechanical properties with copolymers, additives, fillers, modifiers, photoinitiators, and the like. Any of the materials mentioned with respect to the substrate 410 may also be used. In some examples, the substrate 410 may form a column layer, while in other examples, the collapsible nanopillars 406 may be directly formed on the substrate 410.

In a nano-embossing process, a column layer may be softened and then run through a die to imprint the collapsible nanopillars 406. Any number of other processes known in the art may be used to form the collapsible nanopillars 406 from a column layer. Further, the column layer may be part of the substrate 410 and lithographic and other etching techniques may be used.

In some examples, the collapsible nanopillars 406 may be deposited on the substrate 410, for example, using nano-printing, ion deposition techniques, and the like. In a nano-printing process, the materials forming the collapsible nanopillars 406 may be directly deposited, or printed, on the surface of the substrate 410. In other examples, nano-wires may be grown on the substrate 410 through ion deposition or chemical vapor deposition. In growing the nano-wires to produce the flexible column, nano-wire seeds may be deposited onto the substrate 410. The nano-wire seeds may be silicon nano-structures, and the nano-wires may be silicon dioxide structures grown during chemical vapor deposition from silane. Once the collapsible nanopillars 406 are formed, metal caps may be formed over the nanopillars.

As shown in FIG. 4, the example analysis chip 122 has ordered array of microdots 404 deposited thereon. For example, the ordered array of microdots 404 may have been deposited using the systems 100 or 900. As seen in the first exploded side view 400B, the portions of the analysis chip 122 with ordered array of microdots 404 include a number molecules of an analyte 408 on and between collapsed collapsible nanopillars 406. For example, the analytes may be a type of molecule that has good affinity with metallic substrates. In one example, the analyte is composed of trans-1,2-bis(4-pyridyl)-ethylene (BPE) molecules used with a gold substrate. In some examples, the collapse of the flexible nanopillars is induced by microcapillary forces from an evaporating fluid, such as the ink of the deposited ordered array of microdots 404. In some examples, a strong enhancement in surface-enhanced luminance may be obtained from the nanopillars when they are collapsed into groups, termed collapsed groups herein. The enhancement is based on intense local electric fields generated by the plasmon resonance of adjacent metal caps at the top of the collapse to nanopillars, which may be separated by a narrow gap on the nanometer (nm) scale.

The nanopillars may be supported by a substrate 410. For example, the substrate 410 may be made from silicon, glass, quartz, silicon nitride, sapphire, aluminum oxide, diamond, diamond-like carbon, or other rigid inorganic materials, such as metals and metallic alloys. In some examples, the substrate 410 may be a polymeric material, such as a polyacrylate, a polyamide, a polyolefin, such as polyethylene, polypropylene, or a cyclic olefin, a polycarbonate, polyesters such as polyethylene terephthalate, polyethylene napthalate, or other polymeric material suitable for making films. Any of these polymeric materials may be a copolymer, a homopolymer, or combination thereof. In some examples, the substrate 410 may be a web used in a roll-to-roll fabrication process. The substrate 410 together with the collapsible nanopillars 406 or any other suitable surface enhancement is referred to herein as a surface-enhanced substrate. In some examples, the surface-enhanced substrate is any plasmonic sensing substrate, including nanofabricated substrates, colloidal suspensions on paper, or any other plasmonic enhancement platform. For example, the surface-enhanced substrate may be a Surface-Enhanced Raman Spectroscopy (SERS) surface, a surface-enhanced infrared absorption (SEIRA) surface, or a Surface-Enhanced Luminescence (SEL). Such surface-enhanced substrates may be intrinsically super-hydrophobic because of micro- or nano-pillar or other micro- or nano-structures. The hydrophobic nature of these structures allows calibration droplets to stay localized in a very small area. For example, the area may have a diameter of approximately 50 micrometers for 20 pico-liter droplets.

The ordered array of microdots 404 can be analyzed via a micro-assay using light reflected off the surface-enhanced substrate to generate calibration curves associated with the analysis chip 122, as described in greater detail above and below. For example, in response to an excitation beam, electromagnetic radiation may be emitted from the active surfaces in the analysis chips. The characteristics of the emitted radiation may depend, at least in part, on the analyte species, providing information about the analyte species. The metal caps 412 of the collapsed groups provide a plasmon resonance that may interact with the analyte species enhancing the spectroscopic response of the analyte species. In some examples, the excitation beam and the emitted radiation may be at wavelength ranges extending from the near ultraviolet to the near infrared. For example, this may cover a wavelength range from about 150 nanometers (nm) to about 2,500 nm. In some examples, the mid-infrared regions may be included, such as about 3 micrometers (μm) to about 50 μm. Accordingly, analysis chips 122 having collapsible nanopillars 406 may be used for surface enhanced spectroscopy (SES), such as surface enhanced Raman spectroscopy (SERS), or other surface enhanced luminescence (SEL) techniques, such as fluorimetry or infrared, among others.

In some examples, the ordered array of microdots 404 are then laser treated to eliminate any residual optical effects from the ordered array of microdots 404. For example, the analytes 408 in the ordered array of microdots 404 may be degradable molecules that degrade with laser treatment or any other suitable form of treatment. The analysis chip 122 may be tested via an assay by exposing an analyte 408 to the surface of the surface-enhanced substrate. For example, the analysis chips may be dipped into or sprayed by a liquid containing the analytes 408. The resulting analyte-covered analysis chips can be analyzed. The analysis may be aided by the use of the generated calibration curves from the micro-assay analysis. Moreover, the analysis may not be affected by the ordered array of microdots 404. In case of dynamic substrates, such as collapsible nanopillars 406, the techniques described herein allow to interrogate a small substrate area while leaving most of the sensor region untouched. In some examples, greater than 99% of the total surface-enhanced substrate area may be unaffected by the ordered array of microdots 404.

The block diagram of FIG. 4 is not intended to indicate that the example analysis chip 122 is to include all of the components shown in FIG. 4. Further, the analysis chip 122 may include any number of additional components not shown in FIG. 4, depending on the details of the specific implementation. For example, the analysis chip 122 may include additional microdots in the ordered array of microdots 404, nanopillars, etc. A variety of microdot patterns that can be used are described with respect to FIGS. 5B-5G. In addition, although examples herein focus on the use of the flexible nanopillars, any number of other flexible columnar structures made using various techniques may be used in the design groups. These may include flexible columnar structures grown as nano-wires, conical structures formed by vapor etching, or any number of other structures.

FIGS. 5A-5H are drawings illustrating various example patterns for depositing microdots onto a sensor. FIG. 5A is a drawing that illustrates a single dot pattern 500A. As shown in FIG. 5A, the single dot pattern 500A includes the use of a single microdot 502A having a predetermined amount of a single analyte. For example, each sensor to be analyzed may receive a single microdot 502A during depositing. The use of a single dot pattern 500A may minimize area used for the micro-assay, thus resulting in a larger area available for a subsequent assay.

FIG. 5B is a drawing that illustrates a multi-analyte pattern 500B for an ordered array of microdots, in accordance with examples. The multi-analyte pattern 500B of FIG. 5B illustrates the use of multiple microdots 502A and 502B having different analytes in an ordered array. For example, the multiple microdots 502A and 502B may have the same predetermined concentration of analyte. The multi-analyte pattern 500B may be used to sample multiple points on a surface-enhanced substrate using multiple analytes and average the resulting measurements to generate a more accurate calibration curve based on the averaged measurements. Moreover, the use of a multianalyte pattern 500B may enable multiple linear calibration curves to be generated for a given sensor for a variety of possible analytes that may be used in subsequent assays. The use of an ordered array enables the microdots 502A and 502B to be probed simultaneously by a microlens array.

FIG. 5C is a drawing that illustrates a multi-concentration pattern 500C for an ordered array of microdots, in accordance with examples. The multi-concentration pattern 500C of FIG. 5C illustrates the use of multiple concentrations of an analyte in multiple microdots 502A, 502B, 502C arranged in a line, such as a row, column, or diagonal, across a sensor. For example, the multi-concentration pattern 500C can be used to generate a calibration curve for an analyte based on measures at microdots 502A, 502B and 502C. Such calibration curve can be used to estimate a saturation point of the analyte for a given sensor. Moreover, the calibration curve can be used to predict sensor performance to a given concentration of analyte. The use of a line of microdots with multiple concentrations enables the microdots to be probed simultaneously using a microlens array with a smaller aperture or design.

FIG. 5D is a drawing that illustrates an ordered array of microdots 500D, in accordance with examples. The ordered array of microdots 500D of FIG. 5D illustrates the use of microdots 502A having the same analytes. For example, microdots 502A may have been printed using ink from a common reservoir. The ink may contain one or more analytes. The use of an ordered array enables the microdots 502A and 502B to be probed simultaneously by a microlens array, resulting in more efficient processing of many analysis chips.

FIG. 5E is a drawing that illustrates a multi-concentration pattern 500E for an ordered array of microdots, in accordance with examples. The multi-concentration pattern 500E of FIG. 5E illustrates the use of multiple predetermined concentrations of an analyte. For example, a set of predetermined concentrations for the analyte may be used and multiple microdots deposited for each concentration in an ordered array of microdots. As shown in FIG. 5E, the ordered array includes a first column of microdots 502A having a first concentration, a second column of microdots 502B having a second concentration of the analyte, and a third column of microdots 502C having a third concentration of the analytes. The use of a multi-concentration pattern 500E on a sensor may enable multiple calibration curves to be generated for a variety of possible analytes to be used in subsequent assays.

FIG. 5F is a drawing that illustrates a multianalyte pattern 500F, in accordance with examples. The multianalyte pattern 500F of FIG. 5F illustrates the use of microdots 502A, 504A, and 506 with multiple analytes of the same concentration. The use of multianalyte pattern 500F enables more accurate linear curves to be generated for a given sensor for a variety of possible analytes. The use of a multianalyte pattern 500F also enables multiple linear calibration curves to be generated for a given sensor for a variety of possible analytes that may be used in subsequent assays.

FIG. 5G is a drawing that illustrates a combination pattern 500G, in accordance with examples. The combination pattern 500G of FIG. 5G illustrates the use of multiple microdots 502A, 502B, 502C, 504A, 504B, and 504C of a number of analytes of predetermined concentrations in an ordered array on a sensor surface. In various examples, the microdots 502A, 502B, 502C, 504A, 504B, and 504C are placed near the perimeter of the sensor and away from the center of the sensor. The use of a combination pattern 500G enables the improvements discussed with respect to FIGS. 5B-5F to be included in the same design.

The drawings of FIGS. 5A-5G are not intended to indicate that the example patterns 500A-500G are to include all of the components shown in FIGS. 5A-5G. Further, the patterns 500A-500G may include any number of additional components not shown in FIGS. 5A-5G, depending on the details of the specific implementation. For example, the combination pattern 500G or other patterns 500A-500F may include additional microdots, analytes, or patterns.

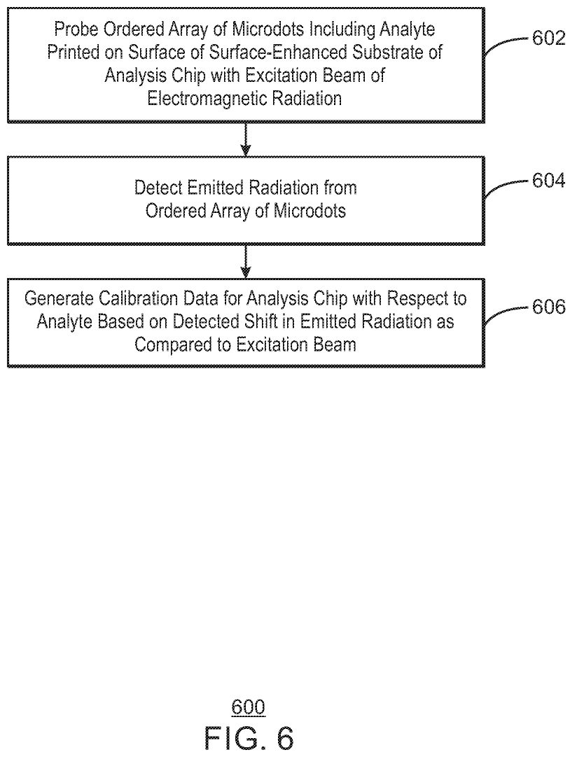

FIG. 6 is a process flow diagram illustrating an example method for generating calibration data, in accordance with examples. The method 600 of FIG. 6 can be implemented in the system of FIG. 1 or the processors 802 or 902 of FIGS. 8 and 9.

At block 602, an ordered array of microdots including an analyte printed on a surface of a surface-enhanced substrate of an analysis chip is probed with an excitation beam of electromagnetic radiation. In some examples, the ordered array of microdots may have been deposited via a microfluidic ejector onto the surface-enhanced substrate of the analysis chip. In some examples, the microdot includes a predetermined concentration of an analyte. In some examples, the ordered array of microdots have different predetermined concentrations of an analyte. In various examples, a spectrometer probes the microdots with an excitation beam of electromagnetic radiation. For example, the excitation beam may be generated by a source of electromagnetic radiation such as a light source. In some examples, the beam is a laser beam.

At block 604, emitted radiation is detected from a plurality of microdots of the ordered array of microdots. For example, the emitted radiation can include light with shifted wavelengths as compared to the light from the light source. In various examples, the emitted radiation is simultaneously detected from the microdots of the ordered array of microdots. In some examples, a row or column of the ordered array of microdots is detected simultaneously.

At block 606, calibration data is generated for the analysis chip with respect to the analyte based on a detected shift in the emitted radiation as compared to the excitation beam. In some examples, the calibration data includes a calibration curve that is a linear curve or a non-linear curve.

It is to be understood that the process diagram of FIG. 6 is not intended to indicate that all of the elements of the method 600 are to be included in every case. Further, any number of additional elements not shown in FIG. 6 may be included in the method 600, depending on the details of the specific implementation. As one example, the method 600 includes estimating a uniformity of the surface of the surface-enhanced substrate based on the captured image. The estimated uniformity is used to print the ordered array of microdots.

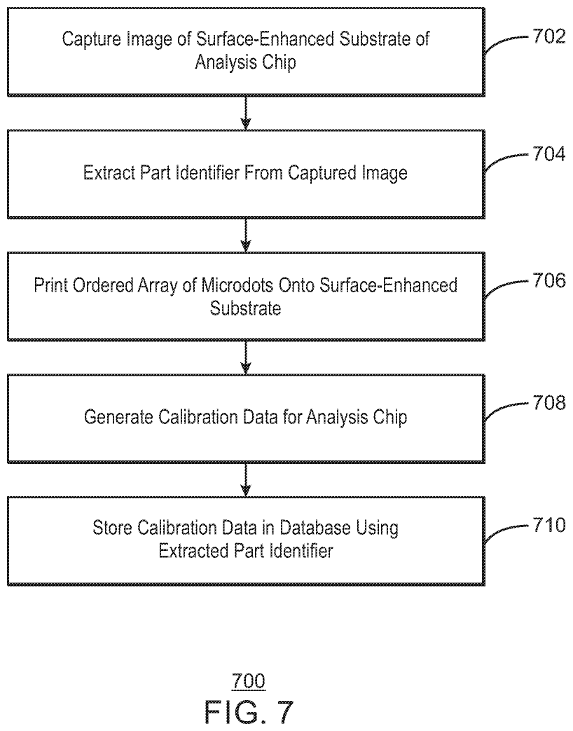

FIG. 7 is a process flow diagram illustrating an example method for generating calibration data, in accordance with examples. The method 700 of FIG. 7 can be implemented in the system of FIG. 1 or the processors 802 or 902 of FIGS. 8 and 9.

At block 702, an image is captured of a surface-enhanced substrate of an analysis chip. In various examples, the image is captured using a camera situated directly above the surface-enhanced substrate.

At block 704, a part identifier is extracted from the captured image. In various examples, the part identifier is laser inscribed into the surface-enhanced substrate during or after fabrication.

At block 706, an ordered array of microdots is printed onto the surface-enhanced substrate. In some examples, the ordered array of microdots may have been deposited via a microfluidic ejector onto the surface-enhanced substrate of the analysis chip. In some examples, the microdot includes a predetermined concentration of an analyte. In some examples, the ordered array of microdots have different predetermined concentrations of an analyte.

At block 708, calibration data is generated for the analysis chip. For example, the calibration data is generated with respect to the analyte based on a detected shift in the emitted radiation as compared to the excitation beam. In some examples, the calibration data includes a calibration curve that is a linear curve or a non-linear curve.

At block 710, the calibration data is stored in a database using the extracted part identifier. In various examples, the calibration data is then retrieved using the part identifier.

It is to be understood that the process diagram of FIG. 7 is not intended to indicate that all of the elements of the method 700 are to be included in every case. Further, any number of additional elements not shown in FIG. 7 may be included in the method 700, depending on the details of the specific implementation. As one example, the method 700 includes extracting an active area from the image and printing the ordered array of microdots based on the active area. In some examples, the method 700 includes extracting orientation and other visual features related to sensor quality from the image. The orientation and the other visual features are used to print the ordered array of microdots.

FIG. 8 is a block diagram of a system to generate calibration curves and perform analysis of spectral content, in accordance with examples. The system 800 includes a central processing unit (CPU) 802 that executes stored instructions. In various examples, the CPU 802 is a microprocessor, a system on a chip (SoC), a single core processor, a dual core processor, a multicore processor, a number of independent processors, a computing cluster, and the like.

The CPU 802 is communicatively coupled to other devices in the system 800 through a bus 804. The bus 804 may include a peripheral component interconnect (PCI) bus, and industry standard architecture (EISA) bus, a PCI express (PCIe) bus, high-performance interconnects, or a proprietary bus, such as used on a system on a chip (SoC).

The bus 804 may couple the CPU 802 to a graphics processing unit (GPU) 806, such as units available from Nvidia, Intel, AMD, ATI, and others. If present, the GPU 806 provides graphical processing capabilities to enable the high-speed processing of images from the camera. The GPU 806 may be configured to perform any number of graphics operations. For example, the GPU 806 may be configured to pre-process the plurality of image frames by isolating regions on which to print microdots, downscaling, reducing noise, correcting lighting, and the like.

A memory device 808 and a storage device 810 may be coupled to the CPU 802 through the bus 804. In some examples, the memory device 808 and the storage device 810 are a single unit, e.g., with a contiguous address space accessible by the CPU 802. The memory device 808 holds operational code, data, settings, and other information used by the CPU 802 for the control. In various embodiments, the memory device 808 includes random access memory (RAM), such as static RAM (SRAM), dynamic RAM (DRAM), zero capacitor RAM, embedded DRAM (eDRAM), extended data out RAM (EDO RAM), double data rate RAM (DDR RAM), resistive RAM (RRAM), and parameter RAM (PRAM), among others.

The storage device 810 is used to hold longer-term data, such as stored programs, an operating system, and other code blocks used to implement the functionality of the system. In various examples, the storage device 810 includes non-volatile storage devices, such as a solid-state drive, a hard drive, a tape drive, an optical drive, a flash drive, an array of drives, or any combinations thereof. In some examples, the storage device 810 includes non-volatile memory, such as non-volatile RAM (NVRAM), battery backed up DRAM, flash memory, and the like. In some examples, the storage device 810 includes read only memory (ROM), such as mask ROM, programmable ROM (PROM), erasable programmable ROM (EPROM), and electrically erasable programmable ROM (EEPROM).

A number of interface devices may be coupled to the CPU 802 through the bus 804. In various examples, the interface devices include a microfluidic ejector controller (MEC) interface 812, an imager interface 816, and a motor controller 820, among others.

The MEC interface 812 couples the processor 802 to a microfluidic ejector controller 814. The MEC interface 812 directs the microfluidic ejector controller 814 to fire microfluidic ejectors in a microfluidic ejector array, either individually or as a group. As described herein, the firing may be performed after imaging of a particular region of a microfluidic ejector array.

The imager interface 816 couples the processor 802 to an imager 818. The imager interface 816 may be a high-speed serial or parallel interface, such as a PCIe interface, a Universal Serial Bus (USB) 3.0 interface, a FireWire interface, and the like. In various examples, the imager 818 is a high frame-rate camera configured to transfer data and receive control signals over the high-speed interface. In some examples, the imager 818 is a multichannel spectroscopic system, or other optical device.

The motor controller 820 couples the processor 802 to a stage translator 822. The motor controller 820 may be a stepper motor controller or a servo motor controller, among others. The stage translator 822 includes a motor, a sensor, or both, coupled to the motor controller 820 to move the stage and attached print medium or collection vessels, under a microfluidic ejector.

A network interface controller (NIC) 824 may be used to couple the system 800 to a network 826. In various examples, this allows for the transfer of control information to the system 800 and data from the system 800 to units on the network 826. The network 826 may be a wide area network (WAN), a local area network (LAN), or the Internet, among others. In some examples, the NIC 824 connects the processor 802 to a cluster computing network, or other high-speed processing system, where image processing and data storage occur. This may be used by a system 800 that does not include a GPU 806 for graphical processing. In some examples, a dedicated human machine interface (HMI) (not shown) may be included in the system 800 for local control of the systems. The HMI may include a display and keyboard.

The storage device 810 may include code blocks used to implement the functionality of the system. In various examples, the code blocks include a capture controller 828 that is used to capture images from the imager 818. For example, the images may depict surface-enhanced substrates having a microdot. In some examples, a GPU 806 is used to identify a region including a surface-enhanced substrate and process the region to detect locations in which to deposit microdots or to detect spectral content from a microdot in the region.

An image processor 830 processes captured images to detect spectral content. In various examples, the spectral content includes an intensity level of a particular portion of the spectrum from one of more of the microdots.

A stage motion controller 832 directs the motor controller 820 to move the stage translator 822. In some examples, the motor controller 820 is used to move a deposit medium, such as an analysis chip including a surface-enhanced substrate, under a microfluidic ejector array. In other examples, the motor controller 820 is used to move an analysis chip including a deposited microdot into a light source for imaging by the imager 818.

An MEC firing controller 834 uses the MEC interface 812 to direct a microfluidic ejector controller 814 to fire a microfluidic ejector. In some examples, this is performed to deposit a microdot including an analyte onto a surface-enhanced substrate of an analysis chip for micro-assay analysis. In other examples, this is performed to deposit microdots or any other pattern of analytes onto surface-enhanced substrate of an analysis chip for assay analysis.

A calibration data generator 836 uses images from the imager 818 to extract spectral content associated with analytes in an ordered array of microdots. In some examples, the calibration data generator 836 calculates a calibration curve based on spectral content associated with the analytes. For example, the calibration curve can be linear or non-linear based on the spectral content. In some examples, the calibration data generator 836 generates a calibration data based on spectral content from microdots having different concentrations of an analyte.

The processor 802 can store the generated calibration data from the calibration data generator 836 in a part identifier store 838. In various examples, the generated calibration data for each analysis chip is stored using the part identifier of the analysis chip.

FIG. 9 is block diagram of another system to separate analytes and perform analysis of spectral content, in accordance with examples. The system 900 can be implemented using methods 600 or 700 via the system 800.

The system 900 includes a processor 902, a dispensing subsystem 904, and an electromagnetic source 906, and an optical system 908. In the system 900, the processor 902 drives the dispensing subsystem 904, the electromagnetic source 906, and the optical system 908.

The dispensing subsystem 904 dispenses an ordered array of microdots onto the sensor area. In various examples, a pitch of the ordered array of microdots matches the pitch of the lenslet microarray. In some examples, the ordered array of microdots is a row or a column of microdots. In other examples, the ordered array of microdots is a matrix of microdots. For example, the matrix includes a number of rows and columns. In some examples, the ordered array of microdots includes rows or columns of microdots having different concentrations of the analyte. In various examples, the ordered array of microdots includes rows or columns of microdots having different analytes. In some examples, the ordered array of microdots includes rows or columns of microdots and each row or column has different concentrations of a different analyte.

The electromagnetic source 906 probes the ordered array of microdots printed on a surface of a surface-enhanced substrate of an analysis chip with an excitation beam of electromagnetic radiation, the ordered array of microdots including a predetermined concentration of an analyte. In various examples, the electromagnetic source includes a number of laser beams. In some examples, the system 900 includes an automated aligner to align focal points of the laser beams with a subset of the ordered array of microdots.

The optical system 908 detects a sensor response. For example, the optical system includes a lenslet microarray to simultaneously detect emitted radiation in the sensor response from a plurality of microdots of the ordered array of microdots. In various examples, the optical system includes an iris to adjust an aperture associated with the lenslet microarray. A subset of the ordered array of microdots is to be detected simultaneously using the adjusted aperture. In various examples, the optical system 908 includes a lenslet microarray. For example, the lenslet microarray has a pitch of 50-500 microns. In some examples, the pitch of the lenslet microarray matches a pitch of the ordered array of microdots.

The processor 902 also generates calibration data for the analysis chip with respect to the analyte based on a detected change in the emitted radiation as compared to the excitation beam. In various examples, the processor receives a part identifier associated with the surface-enhanced substrate. The processor also stores the calibration data in a database using the part identifier.

It is to be understood that the block diagram of FIG. 9 is not intended to indicate that all of the elements of the system 900 are to be included in every case. Further, any number of additional elements not shown in FIG. 9 may be included in the system 900, depending on the details of the specific implementation. In some examples, the system 900 includes an imaging apparatus that captures optical features of a sensor area and a visual identifier.

Although shown as contiguous blocks, the logic components may be stored in any order or configuration. For example, if the storage is a hard drive, the logic components may be stored in non-contiguous, or even overlapping, sectors.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the scope of the appended claims.

What is claimed is:

1. A method comprising:
probing an ordered array of microdots comprising an analyte printed on a surface of a surface-enhanced substrate of an analysis chip with an excitation beam of electromagnetic radiation;
detecting emitted radiation from a plurality of microdots of the ordered array of microdots; and
generating calibration data for the analysis chip with respect to the analyte based on a detected shift in the emitted radiation as compared to the excitation beam.

2. The method of claim 1, comprising capturing an image of the surface-enhanced substrate, extracting a part identifier from the captured image, the part identifier to be used to store the calibration data in a database, and printing the ordered array of microdots onto the surface-enhanced substrate.

3. The method of claim 2, comprising extracting an active area from the captured image and printing the ordered array of microdots based on the active area.

4. The method of claim 2, comprising extracting orientation and other visual features related to sensor quality from the captured image, wherein the orientation and the other visual features are used to print the ordered array of microdots.

5. The method of claim 2, comprising estimating a uniformity of the surface of the surface-enhanced substrate based on the captured image, wherein the estimated uniformity is used to print the ordered array of microdots.

6. A system, comprising:
a dispensing subsystem to dispense an ordered array of microdots onto the sensor area;
an electromagnetic source to probe the ordered array of microdots printed on a surface of a surface-enhanced substrate of an analysis chip with an excitation beam of electromagnetic radiation, the ordered array of microdots comprising a predetermined concentration of an analyte;
an optical system to detect a sensor response; and
a processor to drive the imaging apparatus, the dispensing subsystem, the electromagnetic source, and the optical system, and to generate calibration data for the analysis chip with respect to the analyte based on a detected change in an emitted radiation in the sensor response as compared to the excitation beam.

7. The system of claim 6, the optical system comprising a lenslet microarray to simultaneously detect the emitted radiation from a plurality of microdots of the ordered array of microdots, wherein a pitch of the ordered array of microdots matches a pitch of the lenslet microarray.

8. The system of claim 6, comprising an imaging apparatus to capture optical features of a sensor area and a visual identifier.

9. The system of claim 6, the optical system comprising an iris to adjust an aperture associated with the lenslet microarray, wherein a subset of the ordered array of microdots is to be detected simultaneously using the adjusted aperture.

10. The system of claim 6, wherein the electromagnetic source comprises a plurality of laser beams, the system comprising an automated aligner to align focal points of the laser beams with a subset of the ordered array of microdots.

11. The system of claim 6, wherein the processor is to receive a part identifier associated with the surface-enhanced substrate, wherein the processor is to store the calibration data in a database using the part identifier.

12. The system of claim 6, wherein the ordered array of microdots comprises a row, a column, or a matrix of microdots.

13. The system of claim 6, wherein the ordered array of microdots comprises rows or columns of microdots having different concentrations of the analyte.

14. The system of claim 6, wherein the ordered array of microdots comprises rows or columns of microdots having different analytes, wherein one of the rows or the columns comprises the analyte.

15. The system of claim 6, wherein the ordered array of microdots comprises rows or columns of microdots, each of the rows or each of the columns having different concentrations of a different analyte, wherein one of the rows or the columns comprises different concentrations of the analyte.
